(19) United States
(12) Patent Application Publication
(10) Pub. No.: US 2019/0170317 A1
(43) Pub. Date: Jun. 6, 2019

(54) LIGHT DEVICE, ESPECIALLY SIGNAL LAMP, FOR MOTOR VEHICLES

(71) Applicant: Varroc Lighting Systems, s.r.o., Senov u Noveho Jicina (CZ)

(72) Inventors: Tomas Gloss, Vitkov (CZ); Michal Suder, Ostrava (CZ); Jiri Cienciala, Frydek-Mistek (CZ); Michal Tkacik, Rajecke Teplice (SK)

(21) Appl. No.: 16/204,171

(22) Filed: Nov. 29, 2018

(30) Foreign Application Priority Data
Dec. 1, 2017 (CZ) PV 2017-773

(51) Int. Cl. F21S 43/241; B60Q 1/00

(52) U.S. Cl. CPC F21S 43/241; F21S 43/14; B60Q 1/0011

(57) ABSTRACT

The light device, especially a signal lamp, for motor vehicles, comprises a carrier housing and a translucent cover of the carrier housing that delimit an inner chamber, wherein a planar light-guide is mounted to conduct light rays generated by a lighting element comprising at least one light source, and to emit them from at least a part of the front surface of the light-guide. In the area of the front surface, elevations and/or recesses are formed comprising surface areas of parts of macroscopic crystals

### TECHNICAL FIELD

The invention relates to a light device, especially a signal lamp, for motor vehicles.

### BACKGROUND INFORMATION

Known lamps, especially for motor vehicles, comprise several lighting units, each of these lighting unit fulfilling a different light function, or contributing to ensuring the required emission characteristic of the light trace. Individual lighting means are generally mounted in a molded carrier housing, each lighting unit comprising at least one light source and other optical elements. The light source emits light rays and the optical elements represent a system of refractive and reflective areas and interfaces of optical environments that influence the direction of light rays within the production of the output light trace.

From the documents CZ305740B6, WO2014199108A1, and KR2010055984A devices for motor vehicles are known that actively produce light patterns with a spatial light effect in the lit-up state. The signal lamp known from the document CZ305740B6 comprises at least one light source arranged at the input of a spatially shaped planar light-guide fitted with volume-diffusing material and output areas, while in the off state a spatial impression is maintained. If a planar light-guide made of a volume-diffusing material is used, light needs to be bound by means of an input area or edge. To meet the designer requirements, this input area must be concealed in a view of the inner space of the light device. For this purpose, a covering mask must be used that covers some parts of the light device in the front view. A disadvantage of this device is the fact that the covering mask represents an extra part, which results in higher installation requirements. Also, the advantages of two-stage plastic injection molding making it possible to combine clear transparent parts and covering opaque parts in an integral molding cannot be used.

The document CZ305927 discloses a light device comprising a light-guide using as the light source an array of LED's situated on printed circuit boards. The shaped light-guide comprises a flat base plate with a shaped outline whose inner front forms a binding area for the entry of light rays from the LED's directed against this inner front, and along the edge of its outer front, a set of prismatic unbinding segments is provided that have variable spatial orientation and are directed towards the base plate. The light-guide is further terminated with an unbinding edge for the output of light rays. A disadvantage of this design is the fact that a spatial light effect can only be achieved through the unbinding edges situated at the outer end of the light-guide, which results in limited designer options of shaping the light-guide.

The document CZ20160741 discloses a light device that comprises a carrier housing covered by a translucent cover delimiting an inner chamber wherein a planar light-guide is mounted to conduct light rays generated by the lighting means. The lighting means comprises at least one light source to emit light rays from at least a part of the front surface of the light-guide wherein the light-guide comprises at least one reflective area to reflect light rays conducted by the light-guide in such a way that at least a part of light rays can proceed towards the front surface. In one embodiment, the planar light-guide comprises diffusion particles for diffusion of light rays in its inner structure. Variable luminous intensities coming from different parts of the front surface are used to achieve a light effect, e.g. the lighting crystal effect. A disadvantage of this design is the fact that no elevations and/or recesses are formed in the front surface area that would form surface areas of macroscopic crystals in the inactive state.

The object of the present invention is to provide a light device, especially a signal lamp for motor vehicles, that will produce light patterns with a spatial effect actively in the lit-up state as well as in the inactive state, the optical system of the light device having low installation requirements, the output light functions being homogeneous and the light device being easy to produce at low costs.

### SUMMARY OF THE INVENTION

The object of the invention is fulfilled by a light device, especially a signal lamp, for motor vehicles, according to the invention, comprising a carrier housing and a translucent cover of the carrier housing that delimit an inner chamber wherein a planar light-guide is mounted to conduct light rays generated by the lighting element comprising at least one light source, and to emit them from at least a part of the front surface of the light-guide. In the area of the front surface, elevations and/or recesses are formed that comprise surface areas of parts of macroscopic crystals.

In one of the embodiments, at least some of the said elevations or recesses are produced by formative bending of the flat light-guide body.

In another one of the embodiments, the front surface comprises a base area from which the said parts of macroscopic crystals protrude and/or are formed by the recesses.

In another one of the embodiments, at least some of the parts of the macroscopic crystals overlap each other in a longitudinal sectional view.

In another one of the embodiments, at least some edges and/or corners of the macroscopic crystals are rounded.

In one of the embodiments, the light-guide is configured for the output of light rays from the said surface areas or their parts.

In yet another one of the embodiments, the light-guide is configured for the output of light rays from at least a part of the base area.

The light-guide can comprise at least one reflective area to reflect light rays conducted by the light-guide in such a way as they can proceed towards the front surface.

The reflective area can be configured to reflect light rays conducted by the light-guide directly to the front surface and from the front surface out of the light-guide to produce output light regions on the front surface with a different luminous intensity than exhibited by adjacent locations of this region on the front surface.

In another one of the embodiments, the light-guide comprises a planar binding part to bind light rays that have exited from the lighting element, and an adjacent planar unbinding part that comprises the front surface, the reflective area being part of the binding and/or unbinding part and being configured to reflect rays in such a way to make them proceed through the unbinding part.

The binding part can be made of polycarbonate (PC) or polymethyl methacrylate (PMMA).

The unbinding part can comprise unbinding elements on its outer shell and/or in its inner structure to direct and/or diffuse light rays.

At least a part of the surface of the binding part can be fitted with a reflective layer.

In one of the embodiments, the lighting element comprises a lighting linear light-guide fitted with an input area and an output area, at least one light source being situated at the input area of the lighting linear light-guide and the output area of the linear light-guide being situated opposite the input area of the light-guide.

In another one of the embodiments, the lighting element comprises a lighting planar light-guide fitted with an input area and an output area, at least one light source being situated at the input area of the lighting planar light-guide and the output area of the lighting planar light-guide being situated opposite the input area of the light-guide.

In one of the embodiments, in a view of the inner chamber, behind the light-guide, an active optical element is arranged comprising an area facing the rear area of the light-guide with diffusing and/or reflective properties to return rays that have escaped from the light-guide in other ways than through the front surface back to the light-guide body.

In another one of the embodiments, in a view of the inner chamber, behind the light-guide, at least one reflector is arranged to reflect light rays produced by a secondary lighting element.

At least one of the outer edges of the light-guide can be covered by a covering mask in a view of the inner chamber of the light-guide from the side of the translucent cover.

The lighting element can comprise multiple light sources mounted on a common board.

The light sources can be LED sources.

### CLARIFICATION OF DRAWINGS

The invention will be clarified in more detail with the use of its embodiment examples with references to attached drawings where:

FIG. 1 shows a view of the first embodiment example of a light device according to the invention and its parts in a disassembled state,

FIG. 2 shows a front view of the light device of FIG. 1 with the translucent cover removed,

FIG. 3 shows a front view of the light device with the translucent cover attached and the cross-sections A-A and B-B indicated,

FIG. 4 shows a view of the light device of FIG. 1 in the cross-section A-A indicated in FIG. 3,

FIG. 5 shows a view of the light device of FIG. 1 in the cross-section B-B indicated in Fig.,

FIG. 6 shows a front view of the light-guide and its front surface according to the second embodiment example,

FIG. 7 shows a longitudinal section of a part of the light device comprising the light-guide with the covering mask according to the third embodiment example,

FIG. 8 shows a longitudinal section of a part of the light device comprising the light-guide with the covering mask according to the fourth embodiment example,

FIG. 9 shows a longitudinal section of a part of the light device comprising multiple lighting element according to the fifth embodiment example,

FIG. 10 shows a longitudinal section of a part of the light device according to the sixth embodiment example wherein light rays are bound to the planar light-guide from a side through a linear light-guide,

FIG. 11 shows a longitudinal section of a part of the light device according to the seventh embodiment example wherein light rays are bound to the planar light-guide from a side directly from the light sources,

FIG. 12 shows a longitudinal section of a part of the light device according to the eighth embodiment example wherein light rays are bound to the planar light-guide through an array of optical parts, and

FIG. 13 shows a longitudinal section of a part of the light device according to the ninth embodiment example wherein parts of macroscopic crystals overlap each other in the front view.

### EMBODIMENT EXAMPLES OF THE INVENTION

Before the description of individual particular embodiments, some aspects concerning the invention in general will be mentioned.

The light-guide 3 of this invention is generally planar, i.e. it has the shape of a thin plate that can be variously spatially formed. The “front surface” 9 of the light-guide 3 refers to the surface of the light-guide or its part intended to emit light rays 10 out of the light device. The area of the front surface 9 comprises elevations and/or recesses while generally at least some of these elevations/recesses are formed by surface areas 6 of parts 8 of macroscopic crystals. The fact that the said elevations/recesses are situated in the “area” of the front surface 9 is meant in such a way that the elevations/recesses are not only present e.g. along an edge of the front surface 9.

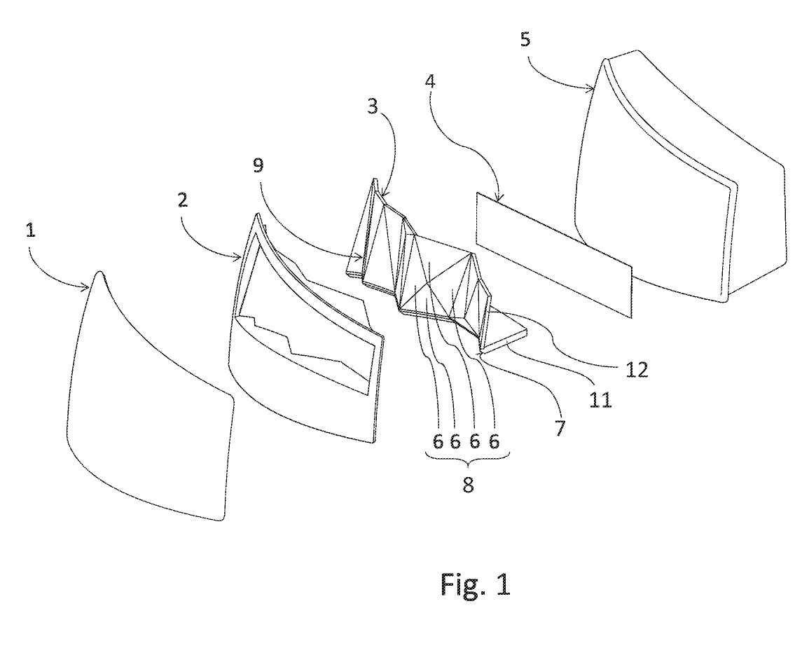

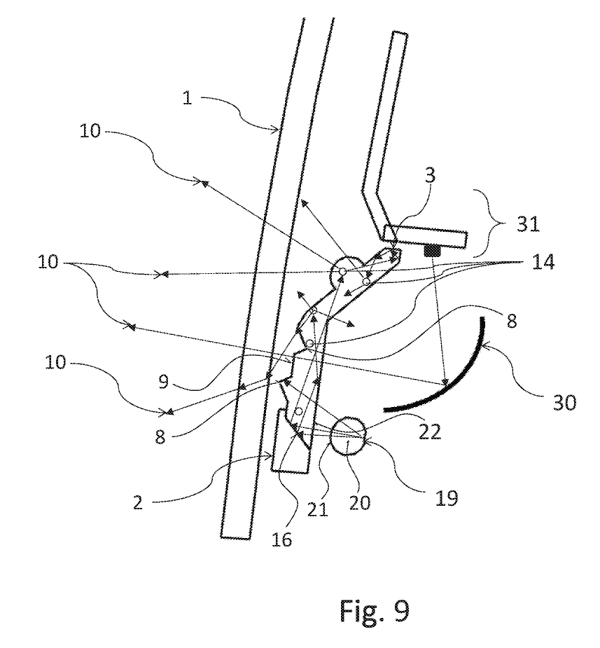

In an embodiment, at least some of the said elevations or recesses are produced by formative bending of the flat light-guide 3 body (understood as bending through the entire thickness of the light-guide 3 body)—see e.g. FIGS. 1 to 8, while in other embodiments (see e.g. FIG. 9), the shape of any of elevations or recesses does not result from such bending of the planar light-guide 3 body.

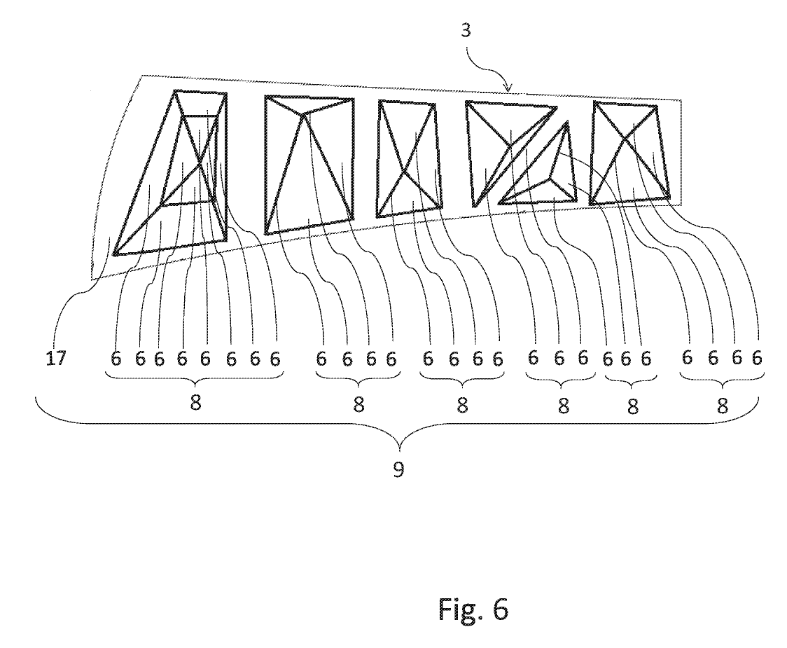

Further, in some embodiments, the front surface 9 of the light-guide 3 comprises a base area 17 that the said parts 8 of macroscopic crystals protrude from and/or are formed by recesses—this is typically the case of the embodiment of FIG. 6.

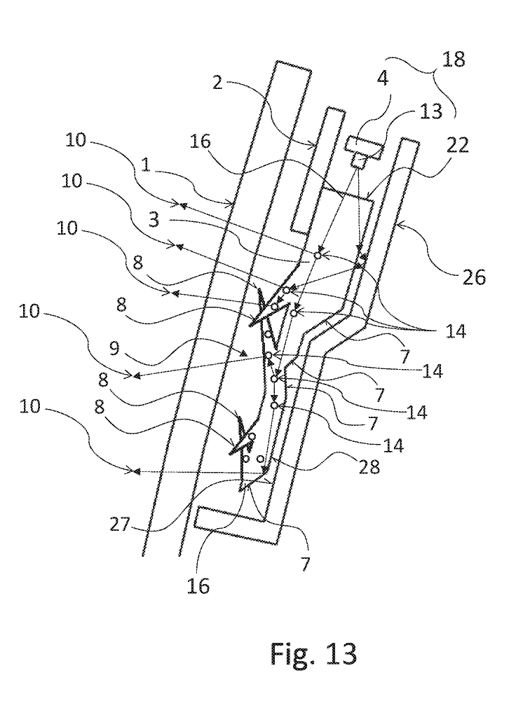

Further, in some embodiments, at least some of the parts 8 can overlap each other in a longitudinal section view—this is the case of the embodiment of FIG. 13.

The invention generally also comprises an embodiment (not shown in the drawings) wherein some edges and/or corners of the parts 8 of macroscopic crystals are rounded.

Concerning the output of light rays 10 from the front area 9 of the light-guide 3, the invention comprises embodiments wherein the light-guide 3 is configured for the output of rays 10 from the whole region of all the surface areas 6, but also embodiments where rays are only output from some of the surface areas 6, or even their parts.

If an embodiment of the invention comprises the base area 17, light rays 10 may exit from the whole base area 17 or from its part only, or in some embodiments, they do not exit from the base area 17 at all.

The light sources 13 according to the invention can be LED sources.

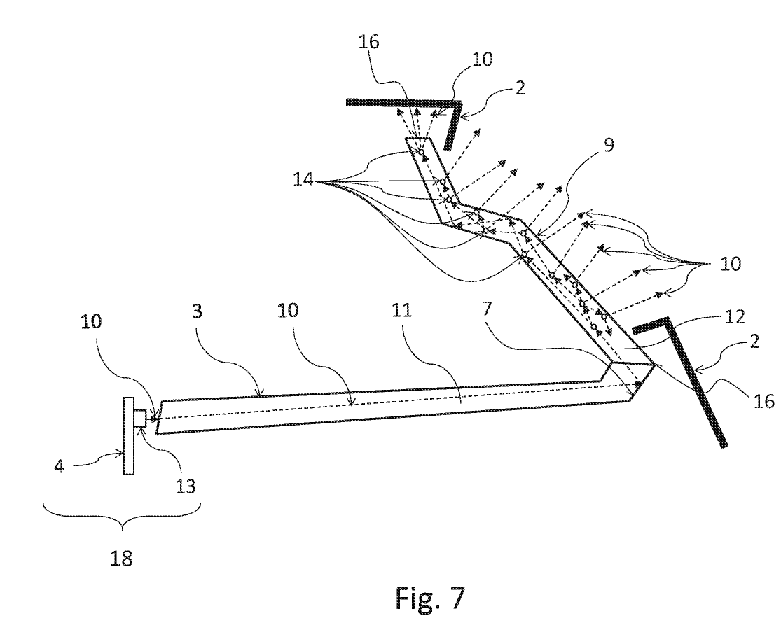

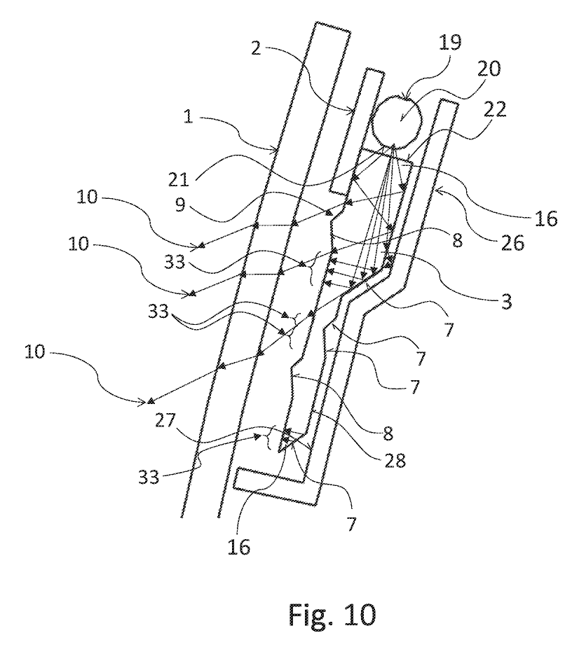

In an embodiment, the light-guide according to the invention comprises at least one reflective area 7 to reflect light rays 10 conducted by the light-guide 3 in such a way to make them proceed through the light-guide 3 towards the front surface 9. This comprises an embodiment envisaged by the invention (see claim 9) wherein the reflective area 7 is configured to reflect light rays 10 conducted by the light-guide 3 directly to the front surface 9 and from the front surface 9 out of the light-guide to produce output light regions 33 (see FIG. 10) on the front surface with a different luminous intensity than exhibited by adjacent locations of this region on the front surface 9. The invention also envisages an alternative configuration of the reflective area 7 wherein the reflective area 7 is configured to reflect rays 10 to another part of the light-guide 3 oriented in a different direction (see the embodiment of FIG. 7).

From the point of view of the effect that is achieved using the inventive solution, it should be mentioned that in the off state, the adjacent surface areas 6 of the parts 8 of macroscopic crystals produce a crystalline effect caused by reflection of daylight (solar radiation) due to a different inclination of the surface areas 6. The result is a different appearance (brightness and reflections) of adjacent surface areas 6. In the lit-up state, an analogous effect is achieved thanks to guiding of light from the light source/s 13 and its unbinding with the use of the surface areas 6, or possibly in embodiments where reflective areas 7 are present, by means of a combination of surface areas 6 and the inclination of the reflective area 7.

Now, to individual particular embodiments.

FIGS. 1 to 5 show the first embodiment example of the light device according to the invention in different views.

FIG. 1 shows the light device in the disassembled condition. The light device comprises a carrier housing 5 designed to hold a planar light-guide 3 that a board 4 carrying not shown light sources 13 that are part of the lighting element 18 to supply the light-guide 3 is associated with.

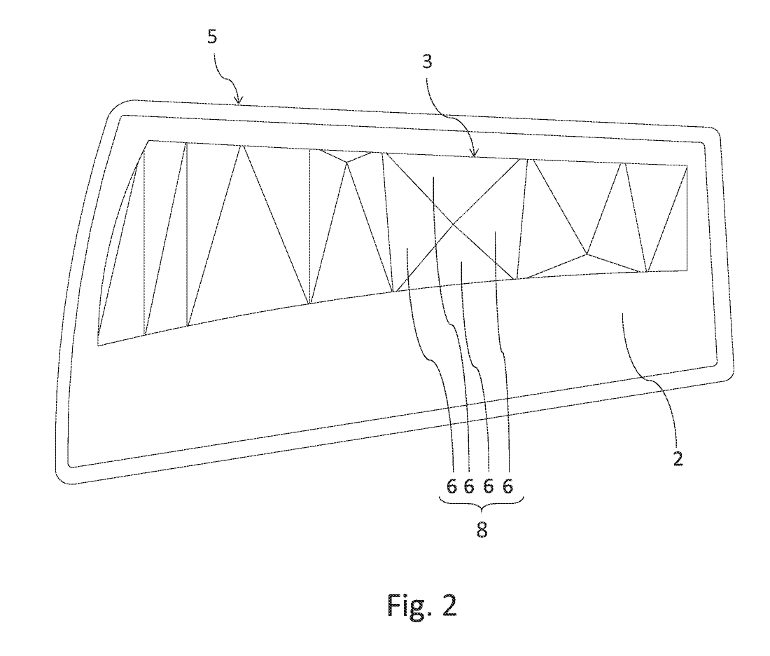

FIG. 2 shows the light-guide 3 with a covering mask 2 mounted in the carrier housing 5. It further shows the surface areas 6 of a part 8 of a crystal. Light rays 10 exit from the surface areas 6 or at least their parts out of the light-guide 3.

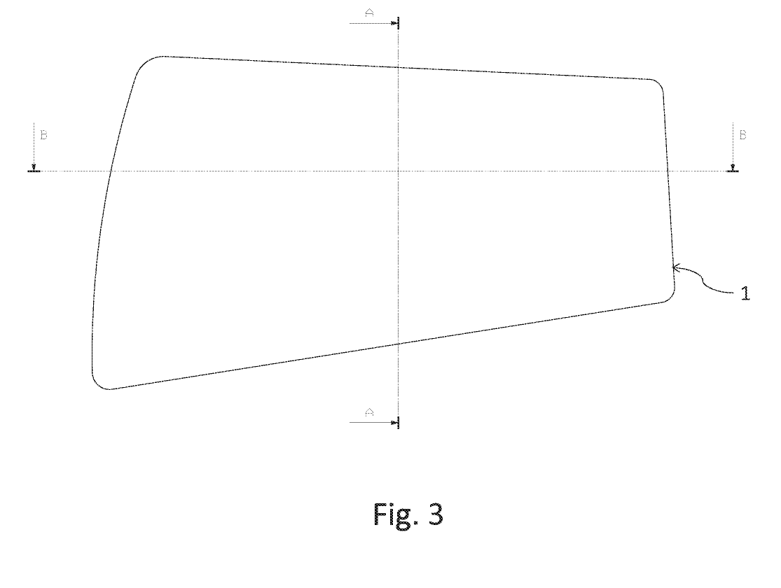

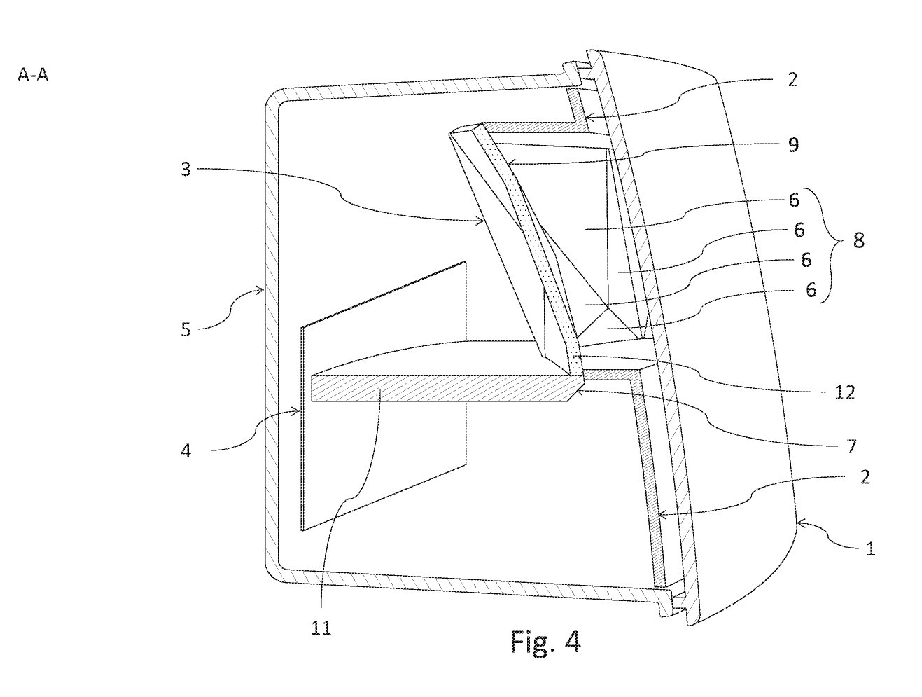

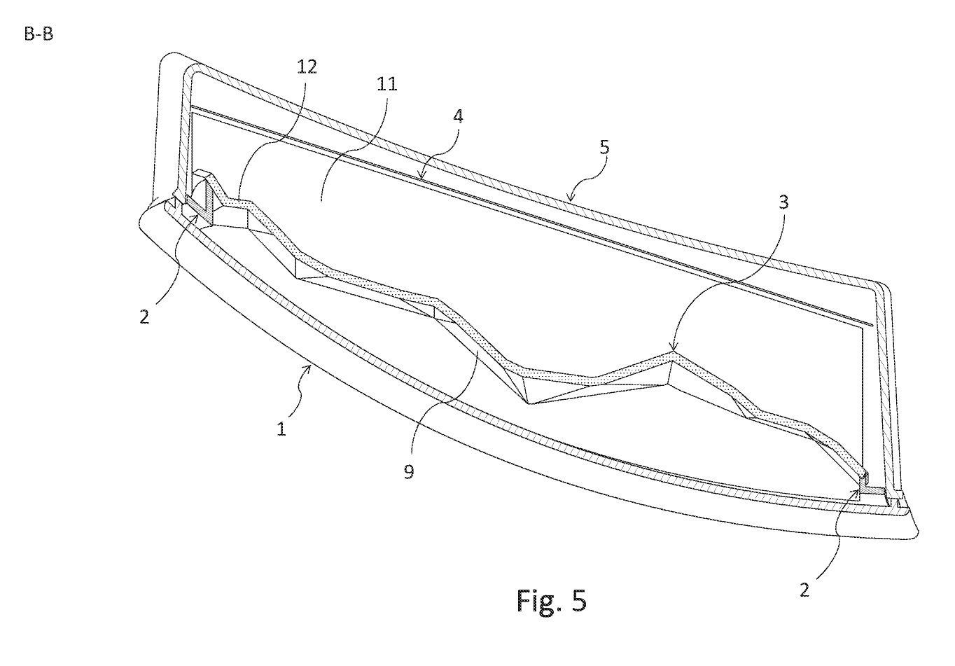

FIG. 3 is a front view of the light device with the translucent cover 1 installed, indicating the cross-sections and corresponding views A-A and B-B, which are then shown in the next FIGS. 4 and 5.

In the assembled condition of the light device, the carrier housing 5 is covered by a translucent cover 1 and it holds a planar light-guide 3 to conduct light rays 10 generated by the lighting element 18 comprising at least one light source 13, and to emit them from at least a part of the front surface 9 of the light-guide 3. The light-guide 3 comprises at least one reflective area 7. In this embodiment, the reflective area 7 is part of the surface of the binding part 11 and is designed to reflect light rays 10 conducted by the binding part 11 of the light-guide 3 in such a way to direct them to the unbinding part 12 and to make them proceed towards the front surface 9. The covering mask 2 is configured in such a way to cover the outer edges 16 of the unbinding part 12 of the light-guide 3 in a view through the translucent cover 1 of the inside of the light device. The unbinding part 12 is plastically (i.e. three-dimensionally—spatially) bent in such a way that the front surface 9 at least partly comprises the surface areas 6 of parts 8 of macroscopic crystals. In general, each of the parts 8 forms a recess or an elevation on the front surface 9 in the front view.

FIG. 6 shows another embodiment example of the light-guide according to the invention. In this example, the front surface 9 of the light-guide 3 comprises a base area 17 while the part of the light-guide carrying the front surface 9 is bent in such a way that parts 8 of crystals protrude from the base area 17, forming elevations on the front surface, while other parts 8 may form recesses with respect to the base area 17. So in this embodiment example, the front surface 9 of the light-guide 3 is partly formed by the base area 17 and partly formed by the surface areas 6.

FIG. 7 shows a longitudinal section of a part of the light-guide 3 with the covering mask 2, according to another embodiment example. The light-guide 3 comprises a planar binding part 11 to bind light rays 10 produced by at least one light source 13, and a bent planar unbinding part 12. The sources 13 can be situated on a common board 4. The sources 13 are part of the lighting element 18. The planar unbinding part 12 carries the front surface 9, which is used to emit light rays 10 out of the light-guide 3. The outer edges 16 of the light-guide 3 are covered by the covering mask 2 in a view of the front surface 9 from the outside of the light device. In this embodiment, the unbinding part 12 comprises unbinding elements 14 in its inner structure to direct and/or diffuse light rays 10. The binding part 11 comprises a reflective area 7 that reflects light rays 10 passing through the binding part 11 to the unbinding part 12.

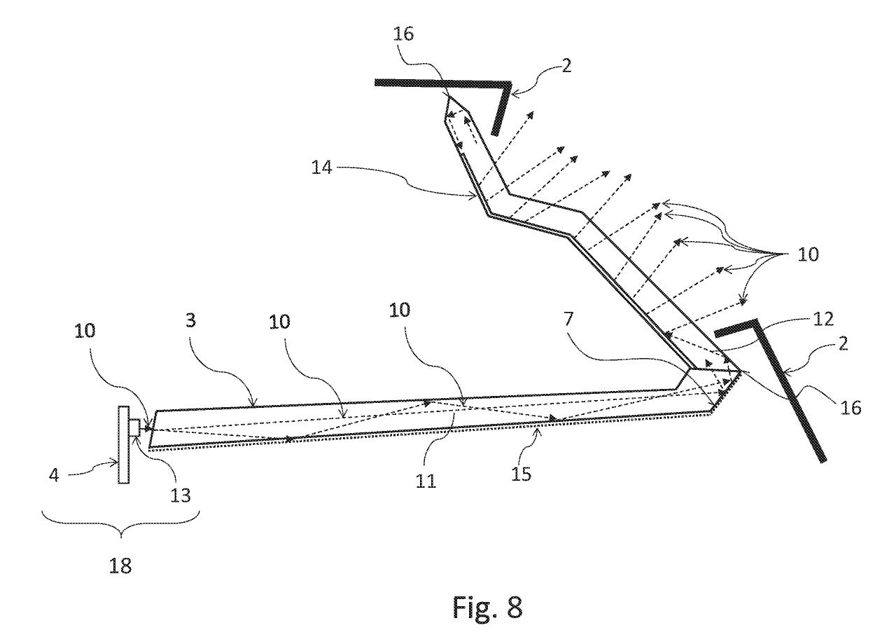

FIG. 8 shows a longitudinal section of a part of the light-guide 3 with the covering mask 2, according to another embodiment example. Similar to the previous embodiment, the light-guide 3 comprises a planar binding part 11 to bind light rays 10 produced by at least one source 13, and a bent planar unbinding part 12. The sources 13 can be situated on a common board 4. The sources 13 are part of the lighting element 18. The planar unbinding part 12 carries the front surface 9, which is used to emit light rays 10 out of the light-guide 3. The outer edges 16 of the light-guide 3 are covered by the covering mask 2 in a view of the front surface 9 from the outside of the light device. The binding part 11 comprises a reflective area 7 that reflects light rays 10 passing through the binding part 11 to the unbinding part 12. In this embodiment, at least a part of the surface of the binding part 11 is fitted with a reflective layer 15 supporting reflection of light rays 10 passing through the binding part 11 from the surface of the binding part 11. The reflective area 7 can also be fitted with a reflective layer 15. Similar to the previous embodiment, the unbinding part 12 is fitted with an unbinding element 14, this time having the form of a layer that adheres from the inside to the surface of the unbinding part 12 opposite its front surface 9 and is configured to reflect light rays 10 to the front surface 9 through which the light rays 10 exit from the light-guide 3. The binding part 11 can be made of polycarbonate (PC) or polymethyl methacrylate (PMMA). As regards the material of the unbinding part 12, it is can be based on material comprising diffusing particles in its inner structure to diffuse light rays.

FIG. 9 shows a longitudinal section of a part of the light device according to another embodiment example. The lighting element 18 comprises a lighting linear light-guide 19 fitted with an input area 20 and output area 21, while at the input area 20 of the lighting linear light-guide 19, at least one light source 13 is situated, and the output area 21 of the linear light-guide 19 is situated against the input area 22 of the light-guide 3. In a view of the inner chamber, at least one reflector 30 is arranged behind the light-guide 3 to reflect light rays produced by the secondary lighting element 31. The light-guide comprises a reflective area 7. In a view of the inner chamber of the light-guide 3 from the side of the translucent cover 1, the outer edges 16 of the light-guide 3 are covered by a covering mask 2.

FIG. 10 shows a longitudinal section of a part of the light device according to another embodiment example. The lighting element 18 comprises a lighting linear light-guide 19 fitted with an input area 20 and output area 21 while at the input area 20 of the lighting linear light-guide 19, at least one light source 13 is situated, and the output area 21 of the linear light-guide 19 is situated against the input area 22 of the light-guide 3. In a view of the inner chamber, behind the light-guide 3, an active optical element 26 is situated comprising an area 27 facing the rear area 28 of the light-guide 3 with diffusing and/or reflective properties to return rays 10 that have escaped from the light-guide 3 in other ways than through the front surface 9 back to the light-guide 3 body. The light-guide comprises multiple unbinding reflective areas 7. At least one of the outer edges 16 of the light-guide is covered by a covering mask 2 in a view of the inner chamber of the light-guide 3 from the side of the translucent cover 1.

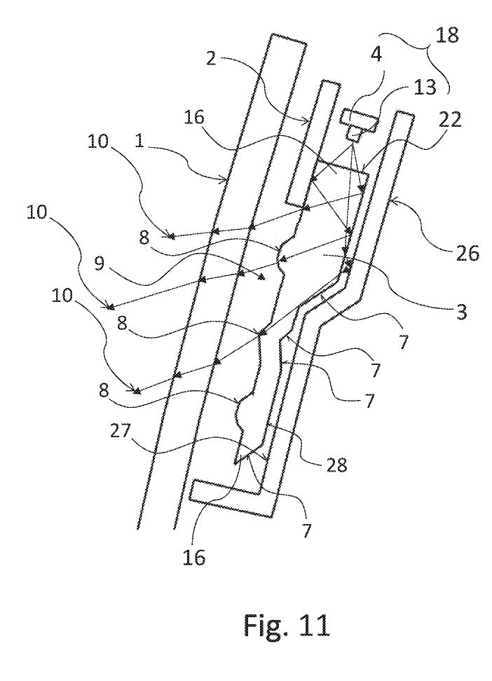

FIG. 11 shows a longitudinal section of a part of the light device according to another embodiment example. The lighting element 18 comprises an array of light sources 13 positioned on a board 4—carrier. The array of light sources 13 is adapted to emit light rays 10 towards the input area 22 of the light-guide 3. At least one of the outer edges 16 of the light-guide 3 is covered by a covering mask 2 in a view of the inner chamber of the light guide 3 from the side of the translucent cover 1. In a view of the inner chamber, behind the light-guide 3, an active optical element 26 is situated comprising an area 27 facing the rear area 28 of the light-guide 3 with diffusing and/or reflective properties to return rays 10 that have escaped from the light-guide 3 in other ways than through the front surface 9 back to the light-guide 3 body. The light-guide comprises multiple unbinding reflective areas 7.

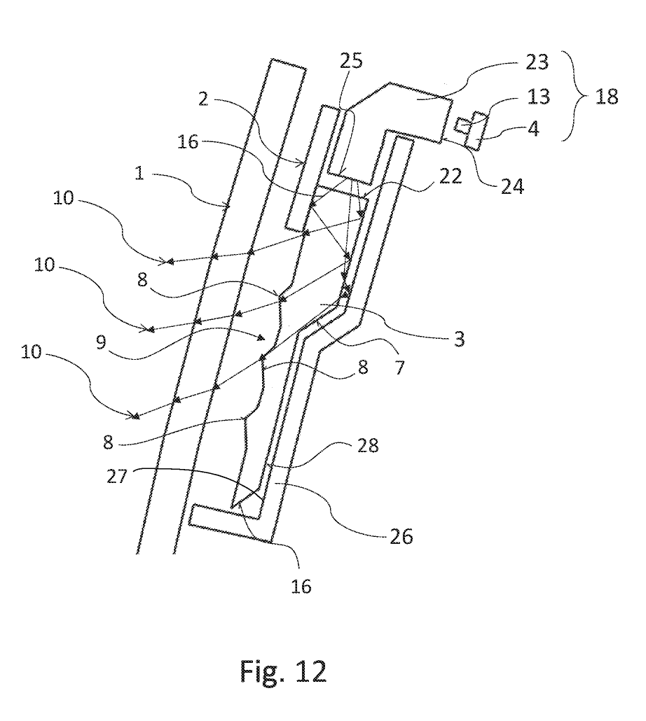

FIG. 12 shows a longitudinal section of a part of the light device according to another embodiment example. The lighting element 18 comprises a lighting planar light-guide 23 fitted with an input area 24 and output area 25 while at the input area 24 of the lighting planar light-guide 23, at least one light source 13 is situated, and the output area 25 of the planar light-guide 23 is situated against the input area 22 of the light-guide 3. At least one of the outer edges 16 of the light-guide 3 is covered by a covering mask 2 in a view of the inner chamber of the light guide 3 from the side of the translucent cover 1. In a view of the inner chamber, behind the light-guide 3, an active optical element 26 is situated comprising an area 27 facing the rear area 28 of the light-guide 3 with diffusing and/or reflective properties to return rays 10 that have escaped from the light-guide 3 in other ways than through the front surface 9 back to the light-guide 3 body. The light-guide comprises multiple unbinding reflective areas 7.

FIG. 13 shows a longitudinal section of a part of the light device according to another embodiment example. The above-mentioned description of the embodiment shown in FIG. 11 applies adequately to this embodiment except that the parts 8 of macroscopic crystals forming elevations on the front surface 9 overlap each other in the longitudinal section view in FIG. 13. In addition, the light-guide 3 comprises unbinding elements 14 in its inner structure to direct and/or diffuse light rays 10.

The present invention is not limited to the embodiment examples described above with references to the respective attached drawings and comprises all adaptations and modifications that fall within the scope of the patent claims below.

### LIST OF REFERENCE MARKS

1—translucent cover
2—covering mask
3—light-guide
4—board
5—carrier housing
6—surface area
7—reflective area
8—part (of a macroscopic crystal)
9—front surface (of the light-guide)
10—light ray
11—binding part (of the light-guide)
12—unbinding part (of the light-guide)
13—light source
14—unbinding elements
15—reflective layer
16—outer edge
17—base area
18—lighting element
19—lighting linear light-guide
20—input area (of the lighting linear light-guide)
21—output area (of the lighting linear light-guide)
22—input area (of the light guide)
23—lighting planar light guide
24—input area (of the lighting planar light-guide)
25—output area (of the lighting planar light-guide)
26—active optical element
27—area
28—rear area
30—reflector
31—secondary lighting element
33—region

1. A light device for motor vehicles, comprising a carrier housing and a translucent cover of the carrier housing that delimit an inner chamber wherein a planar light-guide is mounted to conduct light rays generated by a lighting element comprising at least one light source, and to emit them from at least a part of the front surface of the light-guide, wherein in the area of the front surface, elevations and/or recesses are formed comprising surface areas of parts of macroscopic crystals.

2. The light device according to claim 1, wherein at least some of the said elevations or recesses are produced by formative bending of the flat light-guide body.

3. The light device according to claim 1, wherein the front surface comprises a base area that the said parts of macroscopic crystals protrude from and/or form recesses therein.

4. The light device according to claim 1, wherein at least some of the parts of macroscopic crystals overlap each other in the longitudinal sectional view.

5. The light device according to claim 1, wherein at least some of the edges and/or corners of the parts of macroscopic crystals are rounded.

6. The light device according to claim 1, wherein the light-guide is configured for the output of light rays from the said surface areas of parts of macroscopic crystals or their parts.

7. The light device according to claim 3, wherein the light-guide is configured for the output of light rays from at least a part of the base area.

8. The light device according to claim 1, wherein the light-guide comprises at least one reflective area to reflect light rays conducted by the light-guide in such a way to make them proceed through the light-guide towards the front surface.

9. The light device according to claim 8, wherein the reflective area is configured to reflect light rays conducted by the light-guide directly to the front surface and from the front surface out of the light-guide to produce output light regions on the front surface with a different luminous intensity than exhibited by adjacent locations of this region on the front surface.

10. The light device according to claim 8, wherein the light-guide comprises a planar binding part to conduct light rays that have exited from the lighting element, and an adjacent planar unbinding part that comprises the front surface, the reflective area being part of the binding and/or unbinding part and being configured to reflect rays in such a way to make them proceed through the unbinding part.

11. The light device according to claim 10, wherein the binding part is comprised of polycarbonate (PC) or polymethyl methacrylate (PMMA).

12. The light device according to claim 10, wherein the unbinding part comprises unbinding elements on its outer shell or in its inner structure to direct and/or diffuse light rays.

13. The light device according to any of claim 10, wherein at least a part of the surface of the unbinding part is fitted with a reflective layer.

14. The light device according to claim 1, wherein the lighting element comprises a lighting linear light-guide fitted with an input area and an output area, wherein at the input area of the lighting linear light-guide, at least one light source is situated, and the output area of the linear light-guide is situated opposite an input area of the light-guide.

15. The light device according to claim 1, wherein the lighting element comprises a lighting planar light-guide fitted with an input area and an output area, wherein at the input area of the lighting planar light-guide, at least one light source is situated, and the output area of the lighting planar light-guide is situated opposite an input area of the light-guide.

16. The light device according to claim 1, wherein in a view of the inner chamber, after the light-guide, an active optical element is arranged comprising an area facing the rear area of the light-guide with diffusing and/or reflective properties to return rays that have escaped from the light-guide in another way than through the front surface back to the light-guide body.

17. The light device according to claim 1, wherein in a view of the inner chamber, after the light-guide, at least one reflector is arranged to reflect light rays produced by the secondary lighting element.

18. The light device according to claim 1, wherein at least one of outer edges of the light-guide is covered by a covering mask in a view of the inner chamber of the light-guide from the side of the translucent cover.

19. The light device according to claim 1, further comprising a lighting element, wherein the lighting element comprises multiple light sources installed on a common board.

20. The light device according to claim 1, wherein light sources are LED sources.
